(19) United States
(12) Patent Application Publication
(10) Pub. No.: US 2008/0246730 A1
(43) Pub. Date: Oct. 9, 2008

(54) Computer Input Device with Improved Control Performance

(76) Inventor: Marcel P. Simons, Aalten (NL)

Correspondence Address: OLIFF & BERRIDGE, PLC, P.O. BOX 320850, ALEXANDRIA, VA, 22320-4850, US

(21) Appl. No.: 11/885,863

(22) PCT Filed: Mar. 10, 2006
(86) PCT No.: PCT/NL2006/050053

§ 371 Date: Mar. 17, 2008

(30) Foreign Application Priority Data
Mar. 11, 2005 (NL) 1028523

(51) Int. Cl. G06F 3/033

(52) U.S. Cl. 345/164; 345/163

(57) ABSTRACT

The invention relates to a computer input device comprising means for registering a displacement of said device relative to a substrate for selection of an item on a display panel. The computer input device comprises a device bottom, intended to face said substrate in use of said computer input device. The selection device comprises one or more protruding legs extending from said device bottom. At least one of said protruding legs is shaped to press, during use of said computer input device, a substantially streamlined hole in said substrate.

### FIELD OF THE INVENTION

Generally, the invention relates to the field of computer input devices for selecting an item on e.g. a display panel. An example of such an input device is a computer mouse. More specifically, the invention relates to a computer input device that is adapted for preventing injuries, such as repetitive strain injury (RSI), when operated by a human being, by improving the control performance of the computer input device.

### BACKGROUND OF THE INVENTION

A standard computer mouse may be displaced over a substrate with a horizontally held hand. The mouse can only be displaced in two dimensions, viz. over a flat substrate. The bottom of the computer mouse usually has protruding elements, typically 1 millimetre thick, consisting of a flat, smooth, plastic plate surrounded by a frame, cast from the mouse bottom, to prevent a shifting of the plate. The flat plastic plate protrudes above the frame so that only this plate is in contact with the flat substrate. The frame itself does not contact the surface.

At close inspection of the interaction between the flat plate and the substrate, the irregularities of the flat plate of the leg of the standard mouse catch on the irregularities of the flat substrate. On a microscopic scale both surfaces of the flat plate and the substrate can be compared with “mountain surfaces” that lie on top of each other. This effect is illustrated in FIGS. 1A and 1B. During movement of the standard mouse, the two rough surfaces have “no time” to catch on each other and the resistance is low. As soon as the movement stops, the rough surfaces catch each other and the potential resistance is much increased. To detach the two catching surfaces from one another at the start of the mouse-displacement, a much higher force is needed (peak power) than during the continuation of the mouse displacement. After initiating mouse displacement, the muscle force must be slowed down immediately as, otherwise, the mouse overshoots the intended position.

Especially, for small, precise cursor movements this phenomenon is clearly noticeable. One has to move and slow down the mouse intermittently. The light-footed mouse must therefore be moved carefully which causes much irritation to the user. One cannot move this mouse gradually, slowly. A simple approach to roughen the substrate and/or the flat plates in order to increase the resistance does not help, as then the difference between the peak and propulsion force will only increase and the displacement will be even more jerky.

Furthermore, the phenomenon manifests itself that the friction is not the equally large everywhere because of patches, on the substrate and on the plate, which are flatter, rougher, greasier, dryer or dirty in a varying manner. The combinations of these different patches yield different friction resistances such as e.g. the local rolling over dirt particles, slipping, catching etc. With a constant muscle force, the mouse therefore cannot be displaced with a constant speed. Because one has to position the cursor precisely on the object, a difference in displacement speed is undesirable.

Usually, a person operating a computer mouse tenses the muscles excessively, to create in this manner an internal resistance which controls/slows down the muscle movement at the same time. In addition, the cursor velocity is reduced to be able to position the cursor better. Cursor velocity may e.g. be reduced by changing the software setting for the driver of the computer mouse. For this, however, one has to displace the entire arm to be able to displace the mouse, having as a consequence that the shoulder and the body are being used as a so called “fixed bearing”.

In summary, there exists a need in the art for providing a computer input device, such as a computer mouse, with an improved control performance.

### SUMMARY OF THE INVENTION

A computer input device is provided that comprises means for registering a displacement of said device relative to a substrate for selection of an item on a display panel. The computer input device comprises a device bottom, intended to face said substrate in use of said computer input device. The selection device comprises one or more protruding legs extending from said device bottom. At least one of said protruding legs is shaped to press, during use of said computer input device, a substantially streamlined hole in said substrate.

The invention also provides a combination of the computer input device described in the previous paragraph and a substrate capable of cooperating with said computer input device to form said streamlined hole.

Furthermore, the invention pertains to a protruding leg or set of protruding legs for a computer input device or combination as described above that is constructed and evidently intended for use with the computer input device.

It has been found that the user of the computer input device of the invention experiences a regular, substantially constant, resistance in the direction opposite to the direction of movement directly after initiation of the movement of the input device over the substrate until the final position is reached. The shape of the protruding leg is such that a streamlined hole is formed in the substrate as a result of the pressing of the leg into the substrate. The streamlined hole triggers, in use, a gradual compression of the substrate material in front of a protruding element and a gradual expansion of the substrate after the protruding element has passed. Consequently, a substantially continuous mechanical resistance is experienced by the user of the input device during the entire movement of the input device over the substrate.

In an embodiment of the invention, the protruding legs have a smooth surface arranged for contacting said substrate at a contact area. The smooth nature of the protruding leg at the contact area with the substrate minimizes the friction force between the protruding elements and the substrate.

In order to obtain the streamlined hole in the substrate by pressing of the protruding legs during movement of the computer input device, in an embodiment of the invention the protruding legs have a bevelled and/or rounded shape. In particular, the bevel defines an angle with a horizontal line parallel to said substrate of more than 5 degrees and less than 175 degrees and/or a rounding of the protruding leg defines an angle of more than 10 degrees and less than 170 degrees, measured between the tangential line along the rounding and said horizontal line whereby the tangential line runs through the rounding on the position of the rounding where this tangential line follows the most vertical direction.

In an embodiment of the invention, the protruding leg comprises a rotatable ball at its distal end. The ball rolls in the streamlined hole during displacement of the computer input device. In this way, the friction at the bottom of the streamlined hole is strongly reduced, whereas the sidewall of the leg can press against the sidewall of the streamlined hole for a horizontal resistance.

In an embodiment of the invention, the protruding legs protrude from said device bottom over a distance of at least 2 mm. It has been found that legs of such a length are capable of sufficiently pressing into the substrate to obtain the required streamlined hole.

In an embodiment of the invention, the protruding legs are manufactured from a material or contain a coating that is sufficiently hard to avoid substantial damage of the protruding legs during use. Scratches on the protruding legs may significantly reduce the advantageous effects of the protruding legs.

The invention also relates to a combination of a compute input device and a substrate, a computer input device for use in such a combination, a substrate for use in such a combination and a method of using such a substrate together with a computer input device. A substrate of heat resistant silicones is advantageous as the legs of the computer input device do hardly leave any tracks in the substrate when the computer input device is moved over such a substrate.

It should be appreciated that the protruding legs may be provided separately from a computer input device and be arranged to snugly fit with the device bottom of the computer input device to obtain the advantage of the invention. Accordingly, the invention also pertains to a protruding leg or set of protruding legs as such that comprise attachment structures for attaching said protruding leg(s) to the device bottom of the computer input device. The attachment structures may e.g. comprise sticking surfaces or threaded extensions.

Further embodiments of the invention are defined in claims 14-23 and will be discussed in the description of the preferred embodiment with reference to the drawings. It should be appreciated that the features of claims 16-20, 22 and 23 may also be applied on a standard computer mouse, i.e. independent whether or not the computer mouse comprises the protruding legs according to the present invention.

It should be noted that the above aspects and embodiments may be combined.

The invention will be further illustrated with reference to the attached drawings, which schematically show preferred embodiments according to the invention. It will be understood that the invention is not in any way restricted to these specific and preferred embodiments.

### BRIEF DESCRIPTION OF THE DRAWINGS

In the drawings:

FIGS. 1A and 1B show a schematic detail of a standard computer mouse;

FIGS. 2A-2E show schematic illustrations of shapes of a protruding leg of a computer mouse according to embodiments of the invention;

FIGS. 3A-3H show further schematic illustrations of shapes of protruding legs according to embodiments of the invention;

FIGS. 4A-4C show detailed illustrations in side view and top view of a computer mouse according to an embodiment of the invention;

FIGS. 5A and 5B show front views of a computer mouse according to an embodiment of the invention;

FIG. 6 shows an optical tracking element of a computer mouse according to an embodiment of the invention;

FIGS. 7A and 7B show a further control feature of the computer mouse according to an embodiment of the invention, and

FIG. 8 illustrates the principle of operating buttons on the computer mouse according to an embodiment of the invention.

### DETAILED DESCRIPTION OF THE FIGURES

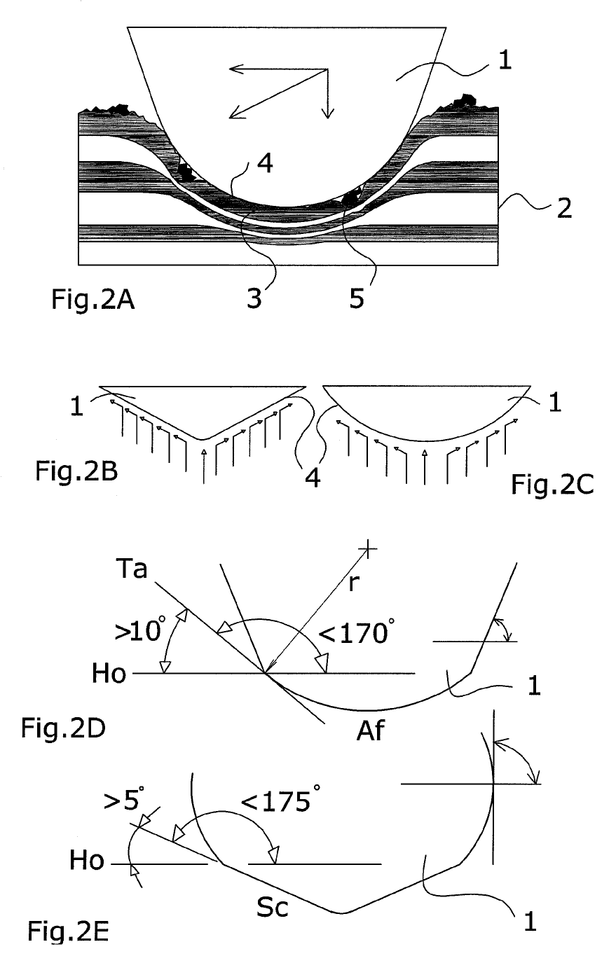

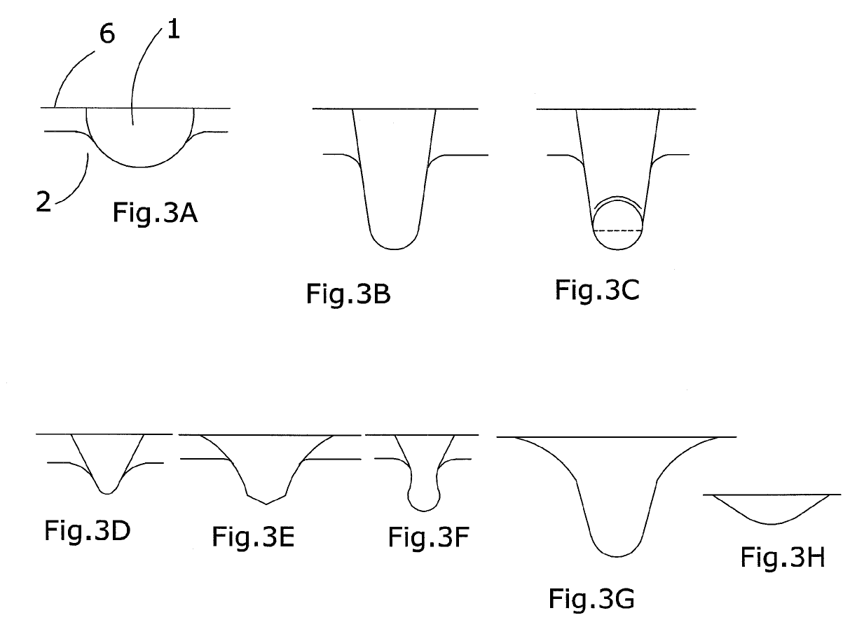

Various embodiments of the invention will now be described with reference to FIGS. 2A-2D and FIGS. 3A-3H.

FIG. 2A shows an illustration of a protruding leg 1 of a computer mouse pressed into a substrate 2. The protruding leg 1 is shaped to form a streamlined hole 3 in the substrate 2. The protruding leg 1 has a smooth and hard surface 4. The rounded leg 1 presses obliquely against the wall of the hole 3 while pressing irregularities 5 into the soft material. The leg 1 is a single part or a combination parts that are permanently attached to each other. The leg 1 has a continuous and smooth surface to form the streamline hole 1. The effect of the shape and smoothness of the protruding leg is that a finite gradual resistance is experienced by the user of the computer mouse, whereas the irregularity of the friction is not increased.

The leg 1 may e.g. be a cone of chrome plated steel. The substrate 2 can be a soft cell- or foam-rubber mat with a smooth, cloth cover or a thick elastic or deep-pile cloth or a greasy (heat resistant silicones/epdm) mat. The word “smooth” relates to a regularly and finely woven fabric; a polished/processed surface (chromium) without grooves or a greasy (carbon-containing PTFE plastic or silicone) surface. Soft means that the material can easily be deformed temporarily. It should be appreciated that the substrate 2 may have a hard base with a soft upper surface allowing the protruding legs 1 to push into the soft upper surface.

In particular with reference to FIG. 2A, the computer mouse has on its bottom hard, smooth, legs 1 (only one is shown) which are bevelled towards the end and/or are rounded. The mouse is put on a soft, homogeneous, flexible, smooth substrate 2 whereby the legs sink into the soft substrate, centring, and form a hole. The protruding, pressed-in, leg 1 can no longer easily “wobble” to all sides but is being held in position, centred.

For the standard computer mouse, the protruding elements typically have a relatively large, flat surface. In order to form a hole in the substrate on which these protruding elements rests, the user should exert a significant vertical force. Even if such a hole is formed, the protruding element will not form a streamlined hole as a result of the edges of the protruding elements. Dirt particles 5 are not pressed into the substrate 2 but gather near and collide with the edges of the protruding elements.

The shape of the legs 1 according to the invention allows the user to produce a streamlined hole in the substrate 2 without having to apply an excessive force. Dirt particles 5 are efficiently pressed into the substrate 2 and cannot collide with the legs 1 as a result of the legs 1 being free of edges.

When the mouse is moved over the substrate 2, the legs 1 work their way through the soft material of the substrate. In this process, the front side of each leg 1 first compresses the soft, flexible, homogeneous material of the substrate 2, whereafter the material of the substrate gradually passes underneath the smooth leg 1. In this way a constant mechanical resistance is experienced opposite to the direction of the displacement of the mouse.

The hard, smooth legs 1 press with the front side against the side of the hole. Here, an average pressure area is determined. Irregularities of the substrate such as dirt, bulges etc. which protrude with respect to the average substrate, are now pressed into the soft material of the wall of the hole by the hard leg 1. A smoothly polished leg will catch minimally to the irregularities of for instance a cloth substrate so that a minimum friction resistance with the substrate 2 occurs. In addition, a hard leg 1 reduces the chance of being scratched itself.

Through the computer mouse an obliquely-directed force can be pressed a) vertically in the direction of the substrate and b) horizontally against the flexible side of the hole 3 in the substrate 2. The muscles of the user can express their energy already without the mouse being displaced with respect to the substrate 2. The muscles therefore do not have to provide careful, subdued force at the beginning of a mouse displacement. The mouse will start to move when the horizontal force is larger than the flexibility of the wall of the hole 3 in the substrate 2 and the small friction between the leg 1 and the material of the substrate 2. By sensing the resistance, one knows how much force and in what direction is needed for a particular displacement.

The force of the hand of the user can be directed more or less vertically, whereby the horizontal force can be dosed accurately e.g. to a strength which just surpasses the resistance, so that the mouse can be displaced down to extremely slowly and at the same time constantly. By directing the force more vertically, the horizontal displacement velocity of the mouse becomes less or the movement is slowed down completely. By pressing the mouse extra hard against the substrate 2, the legs 1 are pressed deeper into the substrate and the resistance is increased so that the mouse can be slowed down further or can be displaced evenly and extremely slow with force.

With this computer mouse, a cursor on a display panel can be moved fast to a virtual object and can, at close proximity hereof, immediately reduce velocity to slowly and precisely position the cursor on the object. The computer mouse may have any type of tracking means to register its movement relative to the substrate 2.

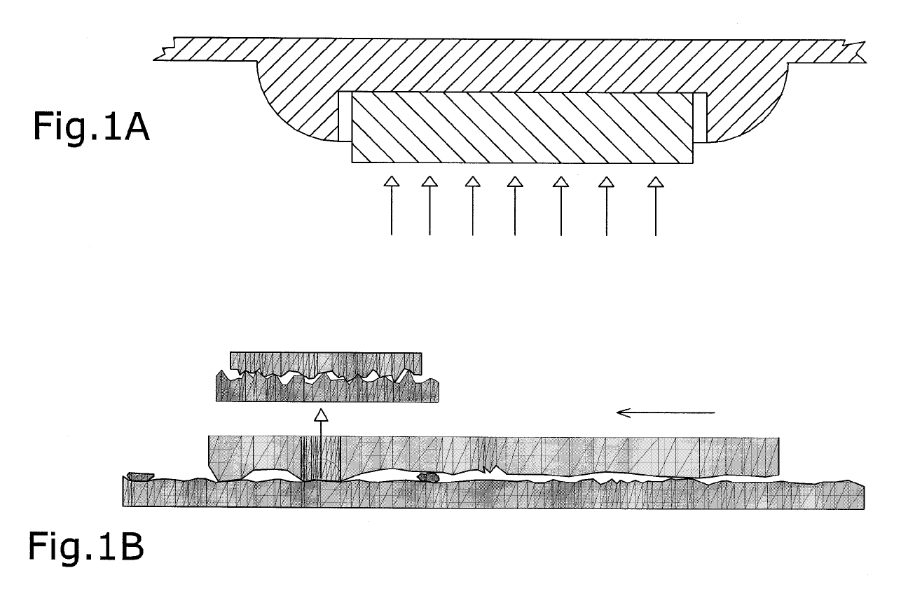

In contrast, the light footed standard mouse with the 1 millimetre thick, smooth, flat protruding elements, discussed in the introduction and shown in FIGS. 1A and 1B, has protruding elements with sharp edges and transitional jumps in the surface. Consequently, the protruding elements are not capable of forming the streamlined hole. Therefore, using the standard mouse, one can only activate muscles to move the mouse and stiffen the muscles to slow down the movement again. The pressing of this standard mouse against the surface friction of a substrate only yields more irregularity in the displacement and grinds the mouse bottom against the surface. To put it differently, the standard mouse lacks control of the mouse movement in the third dimension, i.e. in the direction of the substrate 2, as is the case for the computer mouse according to the invention. Furthermore, the protruding elements of the standard mouse are relatively soft as compared to the hard surface of the legs 1 according to the embodiment of the invention.

The shape of the leg 1 is responsible for obtaining the centred, streamlined hole 3 in the substrate 2. The leg 1 may be bevelled and/or rounded to be able to centre itself in the substrate 2, press a hole 3 herein and to let the material of the substrate 2 slide gradually underneath the leg 1, i.e. from the beginning to the end of the hole 3. The leg 1 can have bevels and/or roundings at the bottom, the sides or between these two sides.

For a bevelled leg 1, the forces experienced by the leg 1 on interaction with a substrate 2 are indicated by the arrows in FIG. 2B. FIG. 2C indicates the forces for a rounded leg 1.

In FIG. 2D, a cross-section of leg 1 is shown comprising a bevelled edge and a rounded bottom. Each rounding on the leg 1 may be more than 10 degrees and less than 170 degrees. This angle is measured between the horizontal line Ho (parallel to the substrate 2) and the tangential line Ta (perpendicular to the radius r of the rounding) which run together through a crossing point on the rounding where the rounding has the most vertical direction. The tangential line Ta is determined at the rounding on the position of the rounding where this line follows the most vertical direction.

FIG. 2E shown a protruding bevelled leg 1. The bevel comprises a sloping sidewall, the angle of which may be more than 5 degrees and less than 175 degrees. This is the bevel angle between a horizontal line Ho(parallel to the substrate 2) and the bevelled plane. In contrast with rounding and bevelled features of the leg 1 of the invention, the contact area of the flat protruding elements during normal use of a standard mouse runs substantially parallel to the substrate 2.

It should be appreciated that a plurality of shapes of the legs 1 may be suitable for pressing a streamlined, centred hole 3 in a substrate 2. FIGS. 3A-3H show a variety of shapes for a leg 1 underneath a device bottom 6 of computer mouse. During use of the computer mouse, the legs 1 are such that the device bottom 6 substantially remains free from the substrate 2.

In FIG. 3A, the leg 1 comprises a semi-spherical leg fixated to the device bottom 6 of the computer mouse.

In FIG. 3B, a more elongated leg 1 rounded at its distal end is shown, mounted underneath the device bottom 6 of the computer mouse.

In FIG. 3C, the distal end of the leg 1 comprises a rotatable ball 7. The ball 7 is capable of rolling in the streamlined hole 3 during the mouse displacement. In this way, the friction at the bottom of the hole 3 is strongly reduced, whereas the sidewall of the leg 1 can press against the sidewall of the hole 2 for a horizontal resistance.

Further shapes for the protruding legs 1 are illustrated in FIGS. 3D-3H. The leg 1 can have the shape of e.g. a cone, a hollow funnel (whirlpool), a multifaceted pyramid, a stepped cone or stepped pyramid etc.

The invention seems to be a paradox because one does not want to experience resistance during the “fast” working with the mouse. However, by virtue of the resistance the mouse can be displaced more accurately and more purposefully so that the cursor speed can be increased (via the software settings of the driver) and the cursor can be positioned on its target directly. In addition the load placed on the muscles is not increased by the increased resistance but they can let flow their force more freely without additional careful, slowing down tensing. Also in other applications RSI complaints appear and the principle of the invention may be transferred to such application.

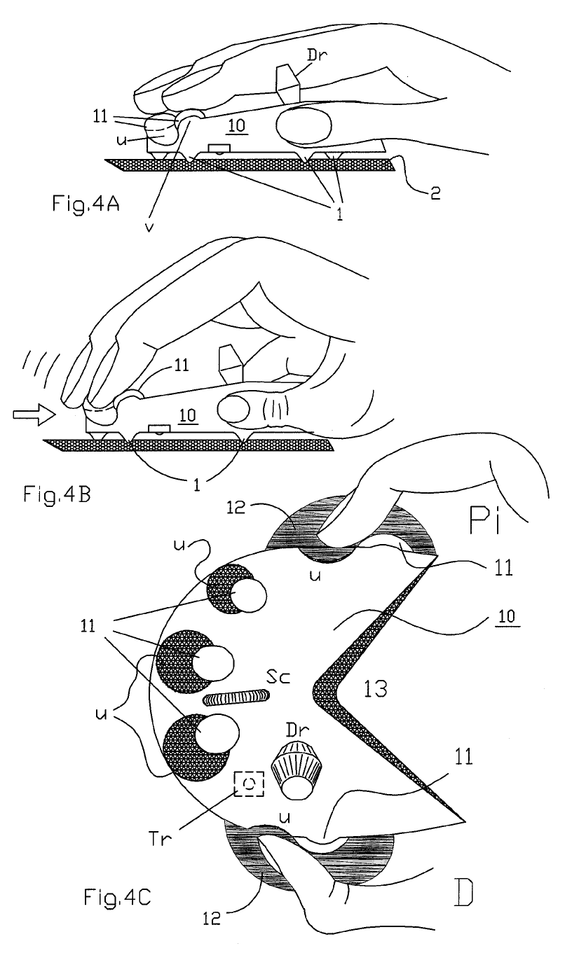

Further advantageous control features of the computer mouse according to the invention will be discussed now with reference to FIGS. 4A-4C, FIG. 5A, FIG. 5B, FIG. 6, FIG. 7A, FIG. 7B and FIG. 8. Said features have advantageous effects in reducing the chance of human injuries when operating a mouse with these features. Consequently, these features can advantageously be applied in combination with the protruding legs 1 of the invention. Therefore, the features are discussed below in combination with a computer mouse having these protruding legs attached beneath the device bottom 6. However, it should be appreciated that each of these features may also be applied in a computer input device without the protruding legs 1.

In FIGS. 4A-4C, a computer mouse 10 is displayed with finger tip sized elevations, on the positions where the fingertips are supposed to lie. On these elevations, caps 11, that may be soft, rough, rounded caps, are applied (e.g. of cellular rubber, soft silicones or linatex). In addition there is a recess u around these caps 11 in the mouse housing (alternatively, one or more of the caps lie on the end of the nose of the mouse). By means of the caps 11, the fingertips can control the mouse sensitively, concentrated. In addition the fingertips can pivot over the caps at the pulling back of the mouse, as shown in FIG. 4B. The ends of the fingers and the nails therefore do not touch the housing of the mouse and therefore do not slide away, which does happen with the standard mouse. If the caps 11 are more oval-shaped, these may be referred to as strips over which the fingers can pivot.

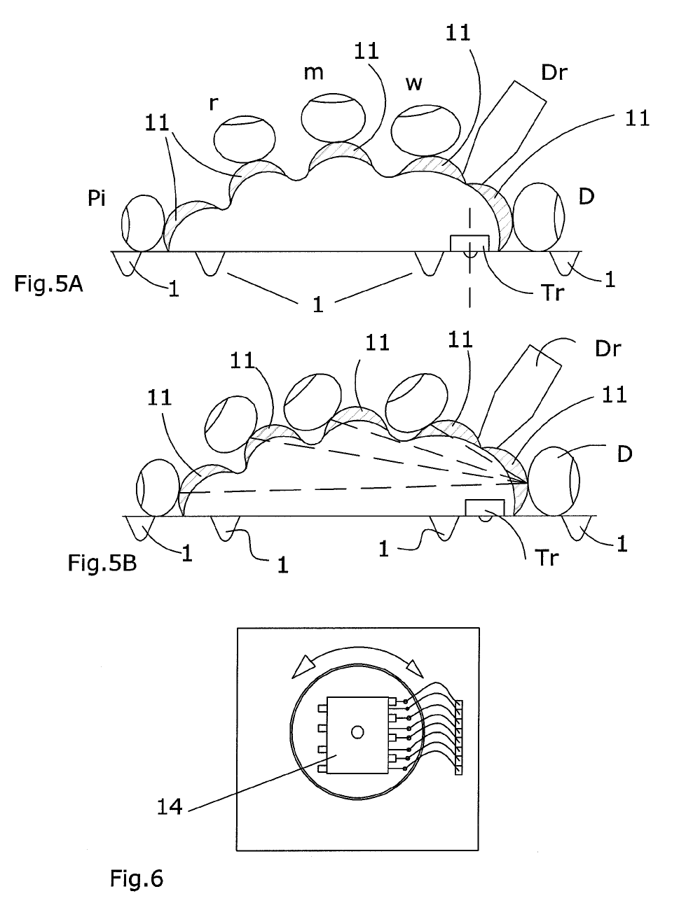

Furthermore, the mouse housing has two flat support strips 12 on the sides on which the little finger Pi and the thumb D can rest. These strips 12 may prevent tilt of the computer mouse. It is noted that the strips 12 may have legs 1 attached to the side facing the substrate 2, as shown in FIG. 5A. These legs 1 may be provided on the strips 1 instead of the legs 1 underneath the main body of the mouse or in addition to the legs 1 underneath the main body of the mouse.

A recess 13 is provided in the back of the mouse housing and a tracking element is schematically indicated by Tr. It can be seen, in FIG. 4C, how the little finger Pi and the thumb D can easily flex/pivot without touching the mouse housing.

As shown in FIGS. 5A and 5B, the fingertips can hold the caps 11 also more to the side. In that way the thumb D and the other fingers w, m, r, and Pi can press in each others direction. The mouse 10 is thus held between the thumb D and the other fingers w, m, r, and Pi, whereas a standard mouse is held only between the thumb and the little finger.

Because the mouse 10 is held via the sensitive caps 11 and is not in contact with other parts of the hand of the user, the user is not distracted and can precisely feel each contact point between the substrate 2 and the legs 1 and follow the displacement tactily. With the standard mouse one does not recognize a contact point.

The mouse 10 comprises a tracking element Tr. The tracking can be optically (camera), magnetically (such as a magnetic pen and tablet) or mechanical (trackball) and takes place preferably directly below and between the positions for the thumb tip D and index finger tip w and not in the middle of the mouse as in the standard mouse. The thumb and index finger can therefore orient themselves in detail to the origin of the cursor and control it accurately.

A further improvement is schematically illustrated in FIG. 6, which shows how an optical tracking element Tr, the CMOS camera 14, can be rotated about the axis of the read-out. The round plate is somewhat tightly fit in a groove of the square plate.

With optical tracking the hardware of the camera 14 and lens are rotatable and adjustable, preferably stepwise, around the detection axis, to enable setting of the correct angle of a cursor displacement with respect to the mouse displacement. In this way, one can e.g. repeatedly try the intuitive, slanted handwriting, and adjust the rotational position of the camera 14 repeatedly until the cursor moves in the desired direction so that the text appears on the screen horizontally. In contrast, with the known setting of this cursor displacement direction using software, one can only make vertical mouse movements and one cannot adjust these any further. In this way one has no relation with the typical slanted writing movement. A setting to obtain for instance handwriting horizontally on the screen, can only be achieved by chance in this way.

Due to the high cursor speed, the novel mouse only needs a small room to move so that the mouse can be used ergonomically with a bent arm in front of the keyboard. The mouse is then oriented more at an angle than at the position next to the keyboard and the cursor direction can be adjusted.

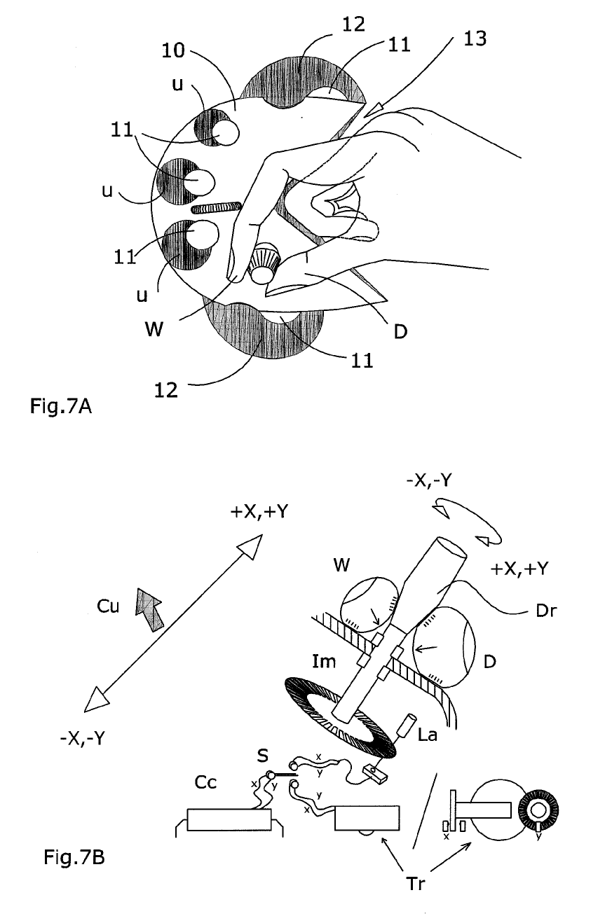

A further improvement will now be described with reference to FIGS. 7A and 7B. FIG. 7A shows the position of the hand of the user of the computer mouse 10 during intensely adjusting virtual parameters by operating a rotation knob Dr with the thumb D and index finger w, whereas the middle finger, ring finger and little finger are flexed inward within the recess 13. In FIG. 7B it is shown how an impulse sender Im generates impulses by means of the rotating knob Dr which, among others, are used for linear x and y cursor displacement impulses. Cu is the cursor on a display panel (not shown) which moves to up-right upon the right (clockwise) rotation of the rotating button or to low-left upon the left (counter clockwise) rotation of the rotating button. The tracking element Tr is shown in two versions, whereby the mechanical tracking with the ball clearly shows the equivalent system of generating impulses by means of a light blade wheel. Switch S switches between the impulses of the rotating button and of the tracking element. La is a laser light with which a high resolution can be achieved. Cc is the control chip of the mouse 10 which sends impulses to the computer.

The impulse sender Im of the present (scroll) wheel and/or rotation button Dr may have a six times higher resolution than with the standard mouse. Due to a lubricated piece of cellular rubber underneath the scroll wheel spindle or a tight fitting, lubricated shaft bearing at the rotating button Dr, one can evenly dose the impulses with a perceptible resistance. The high resolution can be obtained by using laser light instead of LED light. Comparable to the CD read-out, the impulse sender can transmit or reflect very fine light signals.

Scroll data may not only be for the scroll parameter, but also for other parameters (audio-edit). However, not all parameters of each program can be adjusted in their value via the scroll data, but they can be through moving the cursor up and down or left and right. In order to still be able to adjust all possible virtual parameters through the stable rotation of the scroll wheel or the rotating button, the impulses are drawn from the scroll wheel or the rotating button (after switching to this function), split up, and sent to the control chip of the mouse as x- and y-cursor displacement impulses. Hereby the impulses let the cursor move along a straight line in the x and y direction simultaneously and moves the cursor linearly, at an angle across the screen so that universally each virtual rotation or sliding parameter can be adjusted, as shown in FIG. 7B.

In order to be able to select and adapt many virtual parameters quickly after another a separate function may be switched on. This provides that the first few (e.g. five) impulses from the impulse sender are used for the selection command of the indicated parameter on the screen. The selection is kept until the mouse itself makes a reasonable displacement (e.g. with the cursor to a next parameter) whereby the first few impulses from the tracking element again deactivate the selection.

For the intense regulation of parameters (for instance a software audio-video studio) the middle finger, ring finger and little finger can be stably bent inward and lie in the rough covered recess 13 in the rear of the mouse housing (shown in FIG. 7A), while the thumb and the index finger can hold a rotating button. During this the thumb D and the index finger w can lie in a grasping manner between the bevelled edge at the low end of the button and the mouse housing and hold the entire mouse stably and move it e.g. until the cursor indicates the intended parameter. Then, the thumb and the index finger can rotate the rotating button to adjust the parameter value.

The mouse is produced as a right- and as a left handed model. A second mouse, e.g. for the left hand, can be seen as a separate controller. For instance, the right hand can set the cursor on a virtual parameter by means of the mouse, while the left hand operates the wheel or the rotating button to adjust the value of the selected parameter.

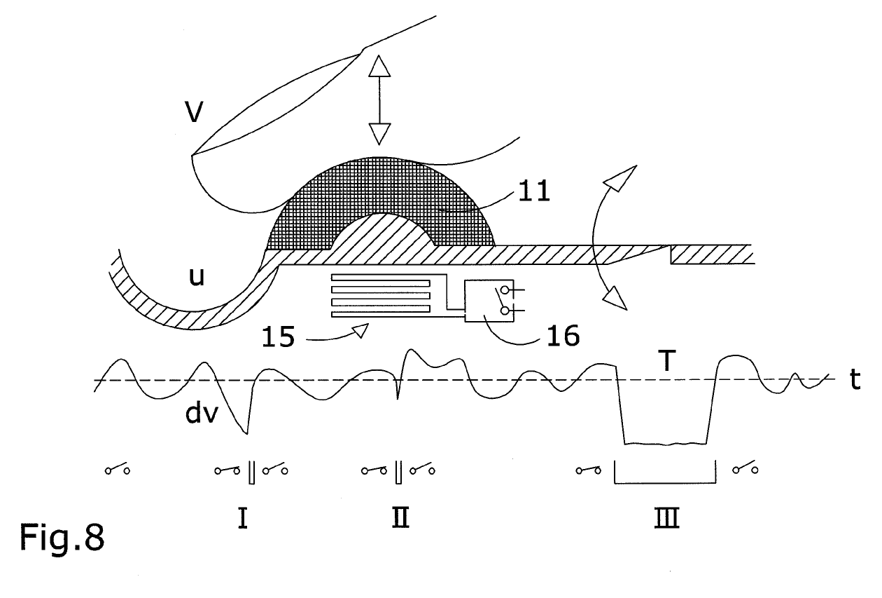

A still further improvement, schematically illustrated in FIG. 8, relates to the manner how the user of the mouse 10 may transmit further input signals from the computer mouse 10 to further equipment. In contrast with the standard mouse, the switching contact of the computer mouse according to an embodiment of the invention is not made by the amount of force (with which a leaf spring flexes, for example) but by the speed with which is pressed on the cap (key) 11 or the speed with which a pressed cap is released. This mechanism in not restricted to the computer mouse of the invention, but may also be applied for the keys of a standard computer mouse. Underneath each cap 11 is a sensitive electronic pressure sensor 15 with which the electric resistance within a voltage circuit can vary when the sensor is pressed harder or softer. The varying resistance value (and current strength) is digitised and sent to a microprocessor 16 which registers the variations within time periods. During the rapid displacement of the mouse or the harder pressing on the mouse (for more resistance to the substrate), the pressure variations and, in combination therewith, the electric resistance variations, are not abrupt, but gradually and within a longer time period. If a cap 11 is pressed quickly and/or released quickly the pressure variation takes place within a short time period. The microprocessor differentiates the slow movements from the fast movements on the cap whereby the fast movement is transmitted as a command signal. One can thus press the cap 11 lightly and quickly or release it quickly for a command signal whereas the fingers can usually lie quietly on the caps 11 or even press these hard without generating a command signal. Further, the microprocessor 16 recognizes a steady pressure, which is larger than the average pressure, after the registration of a quick movement on the cap. During this continuous pressure e.g. a selection is maintained e.g. for dragging a virtual object. After the quick release of this continuous pressure the selection is cancelled.

In particular, as indicated in FIG. 8, a finger V presses on the cap 11 or releases it so that the electrical resistance in the pressure sensor 15 is increased or reduced. Switch S reacts through the processor 16 to rapid pressure changes. Curve dv is the pressure variation along the time line t. It can be seen that a steep contour, caused by a quick finger movement, can be recognized as distinct from the other contours to cause a switching contact. At I, a contact has been made by the rapid release of a built up pressure. At II a light yet quick press has been given on the cap 11. And at III, the cap 11 has been pressed rapidly, the pressure has been maintained (for a continuous switching contact) and released again rapidly. The pressure sensor 15 and switch S may be a bellow with pressure switch, whereby a rapid air pressure increase cannot escape and triggers the switch.

The microprocessor 16 can be the processor of the computer, which can run a program for the recognition of fast or slow electric resistance variations, e.g. connected to the joystick port. Using software the time period for a quick (command) movement can be set as well as the magnitude of the electric variations which are caused by the pressure force of the user.

Instead of an electric pressure sensor 15, a rapid finger pressure variation can e.g. also increase the air pressure underneath the cap. Using a valve with two switch contact points the air can slowly escape the valve, whereas a quick pressure increase presses against the valve and causes an electric contact. Beneath each cap, two switch contacts may be provided to determine the time difference between two signals to retrieve the finger velocity. The mouse may thus have at least two switches. These may be provided at different heights in the mouse and/or have different mechanical pressure resistances. Further, a strip with contact points can be attached underneath the cap, which strip is probed fast or slowly by a slide contact through the movement of the cap, and thus generates a dense or spread out impulse stream.

1. A computer input device comprising means for registering displacement of said device relative to a substrate for selection of an item on a display panel, wherein said computer input device comprises a device bottom, intended to face said substrate in use of said computer input device, and one or more protruding legs extending from said bottom, wherein at least one of said protruding legs is shaped to press, during use of said computer input device, a substantially streamlined hole in said substrate and wherein said device bottom remains substantially separated from said substrate.

2. The computer input device according to claim 1, wherein said protruding legs have a smooth surface arranged for contacting said substrate at a contact area.

3. The computer input device according to claim 1, wherein said protruding legs have at least one of a bevelled and rounded shape.

4. The computer input device according to claim 3, wherein said bevel defines an angle with a horizontal line parallel to said substrate of more than 5 degrees and less than 175 degrees and the rounding of the protruding leg defines an angle of more than 10 degrees and less than 170 degrees, measured between the tangential line along the rounding and said horizontal line whereby the tangential line runs through the rounding on the position of the rounding where this tangential line follows the most vertical direction.

5. The computer input device according to claim 1, wherein said protruding leg comprises a rotatable ball at its distal end.

6. The computer input device according to claim 1, wherein said protruding legs protrude from said device bottom over a distance of at least 2 mm.

7. A combination of a computer input device according to claim 1 and a substrate capable of cooperating with said computer input device to form said streamlined hole.

8. The combination according to claim 7, wherein said protruding elements are manufactured of a material that is hard relative to said substrate.

9. A computer input device for use in the combination according to claim 7.

10. A substrate for use in the combination according to claim 7.

11. The substrate according to claim 10, wherein said substrate comprises heat resistant silicones.

12. A protruding leg comprising:
a protrusion having a distal end, for contacting a substrate, the protruding leg being made of a material having a smooth surface and being hard relative to the substrate;
a rotatable ball at the distal end;
wherein the protruding leg has at least one of a beveled and rounded shape, wherein the bevel defines an angle with a horizontal line parallel to the substrate of more than 5 degrees and less than 175 degrees and the rounding of the protruding leg defines an angle of more than 10 degrees and less than 170 degrees, measured between a tangential line along the rounding and the horizontal line whereby the tangential line runs through the rounding on the position of the rounding where the tangential line follows the most vertical direction.

13. The protruding leg according to claim 12, wherein said protruding element comprises attachment structures for attaching said protruding leg to said device bottom of said computer input device.

14. A computer mouse, that, when lying on a horizontal substrate, can be moved with a horizontally held hand, with a rotation-impulse sender and a tracking-element which registers the displacement of the mouse relative to the substrate, is for the contact with the substrate characterised by one or more hard, smooth legs attached to the bottom of the mouse, which legs have a functional bevelled and/or rounded shape for making, with their bottom end, a centring contact with the substrate and for pressing herein a streamlined hole, with which the mouse experiences, during its displacement over the substrate, a constant resistance in opposite direction to the displacement, without friction-contact between the mouse bottom and the substrate.

15. The computer mouse of claim 14, wherein the bevel of the leg is more than 5 degrees and less than 175 degrees, measured between the bevel and a horizontal line and that a rounding on the leg has an angle of more than 10 degrees and less than 170 degrees, measured between the tangential line along the rounding and the horizontal line whereby these two lines run through the rounding on the position of the rounding where this follows the most vertical line.

16. The computer mouse of claim 14, wherein said computer mouse comprises rounded, soft, flexible, rough, round or oblong caps on top of a locally elevated mouse housing, being finger-tip sized, and a recess in the mouse housing around at least a part of each elevation with a cap so that during normal use of the mouse the finger tips can lie on the elevated caps and can pivot there about without the ends of the fingers and the nails touching the mouse housing.

17. The computer mouse according to claim 14, wherein said computer mouse is arranged for using impulses of the impulse sender, of a rotation wheel or of a rotation knob on the mouse as x- and y-cursor displacement impulses for a linear displacement of the cursor in the x- and y-axis.

18. The computer mouse according to claim 14, wherein said computer mouse comprises a recess at the back of the mouse, keeping the sides of the mouse, so that the little finger, the ring finger and the middle finger can be bent inwards completely, while the thumb and the index finger can simultaneously hold fast a rotating knob, which is chamfered at the low end, and the mouse housing or rotate the rotation knob.

19. The computer mouse according to claim 14, wherein said computer mouse is arranged to assume a functioning mode wherein a virtual parameter is selected through one or more impulses from the impulse sender through the rotation of a rotation wheel or of a rotation knob and that the selected virtual parameter is de-selected through one or more impulses from the tracking element by displacement of the mouse.

20. The computer mouse according to claim 14, wherein said computer mouse is arranged to rotate a camera and a lens of a read-out for the adjustment of the direction of the cursor displacement relative to the mouse displacement.

21. The computer mouse according to claim 14, wherein the leg contains a rotatable ball in the bottom end so that the mouse can roll over and through the substrate.

22. The computer mouse according to claim 14, wherein said computer mouse is arranged such that the tracking by the tracking element takes place below and between the positions for the thumb tip and the index finger tip.

23. The computer mouse according to claim 14, wherein said computer mouse is arranged to register the speed with which a fingertip presses on a mouse cap or releases a pressure, whereby a fast pressure change, relative to the average slow pressure changes, is translated as a command-signal, so that the fingertips can give a command on the novel mouse by a light but quick movement on the caps.
